(19) United States
(12) Patent Application Publication
(10) Pub. No.: US 2008/0134679 A1
(43) Pub. Date: Jun. 12, 2008

(54) Solar powered turbine driven generator system

(76) Inventors: David B. Cavanaugh, San Diego, CA (US); Richard S. Dummer, Escondido, CA (US); Steve L. Palm, Escondido, CA (US)

Correspondence Address: John R. Ross, PO Box 2138, Del Mar, CA, 92014, US

(21) Appl. No.: 11/636,919

(22) Filed: Dec. 11, 2006

(51) Int. Cl. F03G 6/00; F24J 2/04

(52) U.S. Cl. 60/641.8; 60/670

(57) ABSTRACT

A solar powered turbine driven electric generator system. The system generates electrical power by collecting solar energy through the surfaces of an inflatable solar energy collector structure. The collected heat boils a working fluid contained inside the collector structure, generating pressurized vapor. The pressurized vapor drives a turbine/generator, generating electrical power. After the vapor crosses the turbine the excess heat in the vapor is radiated to space, condensing the vapor back to liquid, which is recycled to the collector structure. This form of power system can be scaled to higher levels of power generation in nearly a linear manner by increasing the surface area of the collectors, radiator area, and the capacity of the turbine and generator.

### BACKGROUND OF THE INVENTION

There are a large number of satellites, both military and commercial, currently in orbit around the earth. Other space vehicles are in use exploring the solar system. All of these systems need electric power. Most currently use solar voltaic systems to convert sunlight into electric power and some use nuclear power. As the power requirements approach 100 kilowatts, the size of a solar voltaic array becomes impractical. Nuclear powered systems could supply the needed power, but orbiting nuclear powered system are considered risky.

What is needed is better way to safely generated large amounts of electric power for space systems and vehicles with solar energy.

### SUMMARY OF THE INVENTION

The present invention provides a solar powered turbine driven electric generator system. The system generates electrical power by collecting solar energy through the surfaces of an inflatable solar energy collector structure. The collected heat boils a working fluid contained inside the collector structure, generating pressurized vapor. The pressurized vapor drives a turbine/generator, generating electrical power. After the vapor crosses the turbine the excess heat in the vapor is radiated to space, condensing the vapor back to liquid, which is recycled to the collector structure. This form of power system can be scaled to higher levels of power generation in nearly a linear manner by increasing the surface area of the collectors, radiator area, and the capacity of the turbine and generator. This is possible because the electrical power is generated at a single point that is located close to the payload, thus eliminating lengthy and massive power busses found in solar voltaic systems.

In a preferred embodiment the solar collector is two rectangular panels, each consisting of twenty-five 0.5 meter diameter tubes 24 meters in length spaced at 1.9 meters. These panels therefore each to provide a surface area of about 1152 square meters and an absorption area of about 300 square meters. The two panels together present an absorption area of about 600 square meters. Since the exo-atmospheric solar power is about 1.368 kW/m², this is a sufficient absorption area to receive about 820 kW. With a Rankine cycle steam turbine operating at a projected efficiency of 20 percent, and considering collection efficiencies, the system can produce about 100 kW of electrical power.

The tubular collectors in the preferred embodiment are fabricated from a high-temperature, high-strength composite material, approximately 10 mils in thickness that is reinforced with high tensile strength polymer fiber such as Kevlar. The matrix of the composite material is a rubbery material that is flexible, withstands high temperature and is impermeable to steam. The current preferred matrix material is a “Viton” blend. The outer surface of the preferred collector has a coating that promotes a high absorptivity to solar radiation, and a low emissivity in the thermal infrared. This coating efficiently absorbs the solar energy, and retains the resultant heat energy. In the preferred embodiment the coating is comprised of three layers that are applied to the surface of the above composite material by vacuum deposition. The base layer is 180 Angstroms if TiO₂. The middle layer is 180 Angstroms of metallic silver. The top layer is another 180 Angstrom layer if TiO₂. In the preferred embodiment, the interior surface of the tubular collectors is a thin metal foil that blocks permeation of the working fluid through the tube skin and spreads heat laterally. This metal must be chemically inert to steam.

The preferred basic working fluid is water, which has low molecular weight minimizing system weight. The relatively high boiling point of water (compared to other potential working fluids) reduces the area of the heat exchanger required since a hot body is a much more efficient radiator. In preferred systems two turbine generators are provided each rotating in opposite directions to avoid large net variable torque forces that could adversely affect the attitude of the satellite.

### BRIEF DESCRIPTION OF THE DRAWINGS

FIG. 1 is a basic schematic of a preferred embodiment of the present invention.

FIG. 2 shows the spectral reflectance of a preferred balloon coating candidate.

FIG. 3 shows a preferred reflector design.

FIG. 4 shows a communication satellite powered by an embodiment of the present invention.

FIGS. 5A and 5B show features of a heat exchanger system to provide a working gas for radiator units.

FIGS. 6A and 6B show features of the radiator units.

### DETAILED DESCRIPTION OF PREFERRED EMBODIMENTS

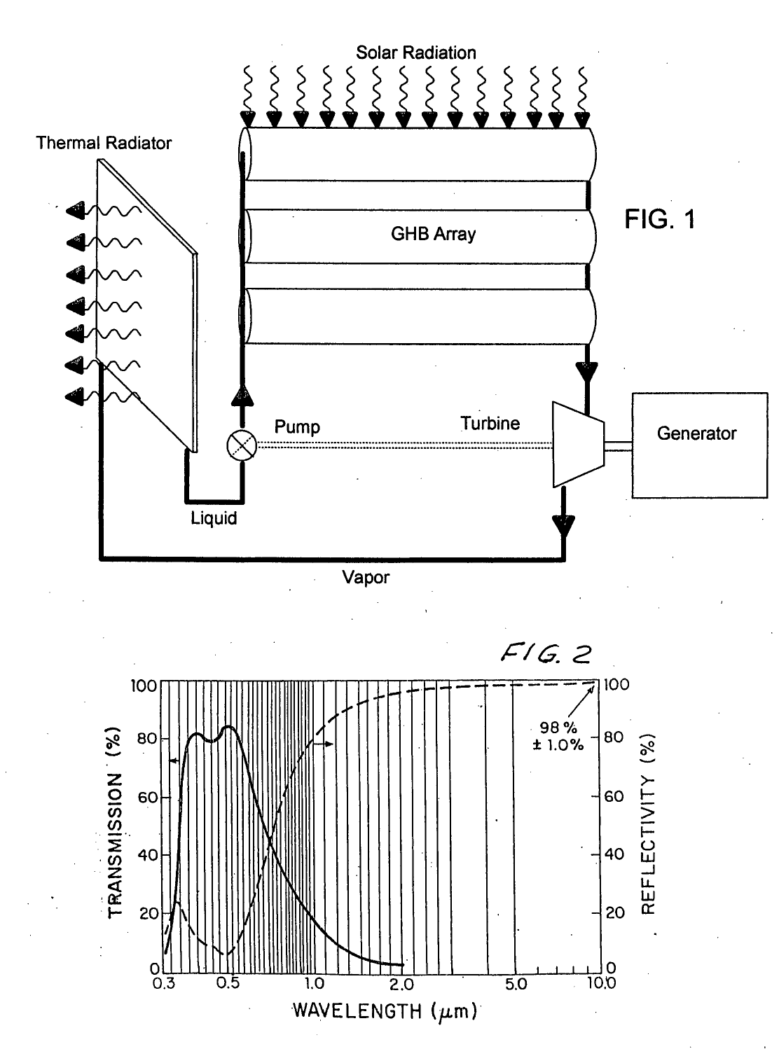

A preferred embodiment of the present invention is referred to by the Applicant as “The Greenhouse Balloon Power System” (referred to in this detailed description as “GHB”. It uses an inflatable structure to collect and transfer solar energy to a pressurized working fluid inside the structure. The pressurized working fluid drives a turbo generator producing electrical power. The heated vapor that has traversed the turbine is condensed in a heat exchange element, and the waste heat is radiated to space. The condensed working fluid is recycled into the Greenhouse Balloon. The basic operational scheme for the GHB system is illustrated in FIG. 1. The GHB collectors generate pressurized saturated vapor which spins a turbine/electrical generator combination. The current preferred thermodynamic cycle of the turbine is the Rankine cycle, although other compatible thermodynamic cycles can also be used.

### Satellite Power System

A current and carefully developed embodiment of the present invention providing power for a communication satellite is shown in FIG. 4. The satellite consists of two GHB power systems 6 arranged symmetrically around the antenna/transmitter payload 8. The GHB collector panels 10 are shown vertical with the reflector panels 12 directly behind them. The turbine and generator (two sets), with the pressure feed and return lines are located above the payload antenna. The thermal radiator panels are perpendicular to, and extend behind the GHB collector arrays. The pointing directions of the collector panels and the antenna are controlled separately.

The current system uses two symmetrical GHB power generation systems. The reason for this is the solar collector arrays have a large area that points into the solar wind. A system with an unsymmetrical aspect ratio will experience a torque, and a secondary propulsion system will be necessary to correct the attitude of the spacecraft. The symmetrical shape shown here does not generate a torque in the solar wind, and the complexity of the attitude control system is thus minimized.

### Solar Collectors

The GHB solar collectors consist of reinforced cylindrical bladders that are designed to hold hot vapor at pressures of the order of 100 psia and temperatures on the order of 160° C. The GHB bladders are flexible when not inflated and can be folded or rolled into small volumes for stowage and launch. Thus, the entire system is designed to fit into the fairing of an Atlas 5 HLV rocket.

The bladders can be arranged in various configurations. The current embodiments arrange the bladders in a parallel structure. The bladders are separated by a minimum distance that prevents the bladders from “shadowing” its neighbors when the GHB raft is kept within a specified angle to the sun. The expected orbital attitude variations determine this specified angle. The bladders are interconnected so that all are connected either in parallel or series to the turbine inlet. The interconnect fittings would include check valves or other safety features at each bladder designed to disconnect the bladder from the system in case of a failure.

In a preferred embodiment shown in FIG. 4, the solar collector is two rectangular panels, each consisting of twenty-five 0.5 meter diameter tubes 24 meters in length spaced at 1.9 meters. These panels therefore are each provide a surface area of about 1152 square meters and an absorption area of about 300 square meters. The two panels together present an absorption area of about 600 square meters. Since the exo-atmospheric solar power is about 1.368 kW/m², this is a sufficient absorption area to receive about 820 kW. With a Rankine cycle steam turbine operating at a projected efficiency of 20 percent and considering collection efficiencies, the system can produce at least 100 kW of electrical power. The reader should note that the FIG. 4 drawing shows only 13 tubes per panel instead of the above 25. This may be the number needed if the reflector contribution turns out to be as effective as hoped.

The outer surface of the GHB tubular collector elements are treated with a coating that selectively absorbs solar radiation with high efficiency. The coating is also designed to retain heat energy in the GHB by having a very low emissivity (i.e. a high reflectivity) in the thermal infrared waveband. Thus, the solar electromagnetic radiation is absorbed by the GHB skin where it is immediately converted to heat energy. The heat energy is trapped very efficiently by the GHB because the outward radiative loss pathway is blocked by the low emissivity coating, and because the outward convective heat loss pathway is not effective in the vacuum of space. The trapped heat thus diffuses to the interior of the GHB where it is absorbed by the working fluid. The coating performance is illustrated in FIG. 2. The coating on the outer surface of the GHB is absorptive to solar light (left side of chart) at about 65 percent and highly reflective to infrared radiation (right side of chart).

Making the Collector Tubes

The GHB collection tubes are preferentially cylindrical in shape to facilitate manufacture. The GHB material is a fiber-reinforced composite as explained above. The fiber reinforcement should have a low mass density, be flexible with a high tensile strength that retains its strength when exposed to steam. Kevlar is the currently the preferred fiber, but other high tensile polymer fibers are currently under study. The Kevlar is applied to the GHB by continuous winding onto a cylindrical mandrel, which forms a seamless material. The fiber is wound both in the “hoop” direction around the cylinder circumference, and longitudinally, parallel with the cylinder length. The fiber is impregnated with the matrix rubber material before winding to eliminate voids in the finished material. The matrix of the composite is a rubbery material that is flexible, withstands high temperature and is impermeable to steam. The current preferred material is a “Viton” blend, although several other rubber candidate materials are currently under study. The thickness of the GHB composite skin is approximately 10 mils (0.01″).

The outer surface of the GHB has a thin film coating that absorbs sunlight and has low emissivity in the thermal infrared. The current preferred coating is composed of three layers that are applied to the surface by vacuum deposition. The base layer is 180 Angstroms if TiO₂. The middle layer is 180 Angstroms of metallic silver. The top layer is another 180 Angstrom layer if TiO₂. This coating has been successfully applied to several samples of the various rubber materials that are under study, and give the performance indicated in FIG. 2. The rubber surface may also be pre-treated by depositing thin layers to the rubber surface, for example a chromium metal, which improves the coating adhesion and the solar absorption properties. Other coatings are also currently being explored, such as black oxides of metals such as chromium or copper.

The interior surface of the GHB is a thin metal foil that blocks permeation of the working fluid through the GHB skin and spreads heat laterally. This metal must be chemically inert to steam, and thus a common metal such as aluminum is unsuitable. The metal foil is also the base layer that the “wet” components of the GHB cylinder are applied to during manufacture. Applicants currently prefer manganese although several options are available including some non-metals and composites.

The preferred diameter of the GHB cylinders is determined by several factors. The effective collection area of the GHB cylinders is equal to the (diameter×length). The GHB elements in the current embodiment must collect solar power to provide the desired electrical power output. The turbine efficiency is determined by the thermodynamic cycle used, and in the case of the Rankine cycle an efficiency of 20 percent might be expected. The exo-atmospheric solar power is 1.368 kW/meter².

The optimal diameter of the GHB is a complex function. A larger diameter GHB gives a large collection area per unit length of GHB cylinder, which is desirable. However, as the diameter of a pressure vessel increases the hoop tensile strength required of the walls increases as the square of the hoop radius. Thus, a smaller diameter GHB will have thinner walls, and thus a lower specific mass.

### Reflector

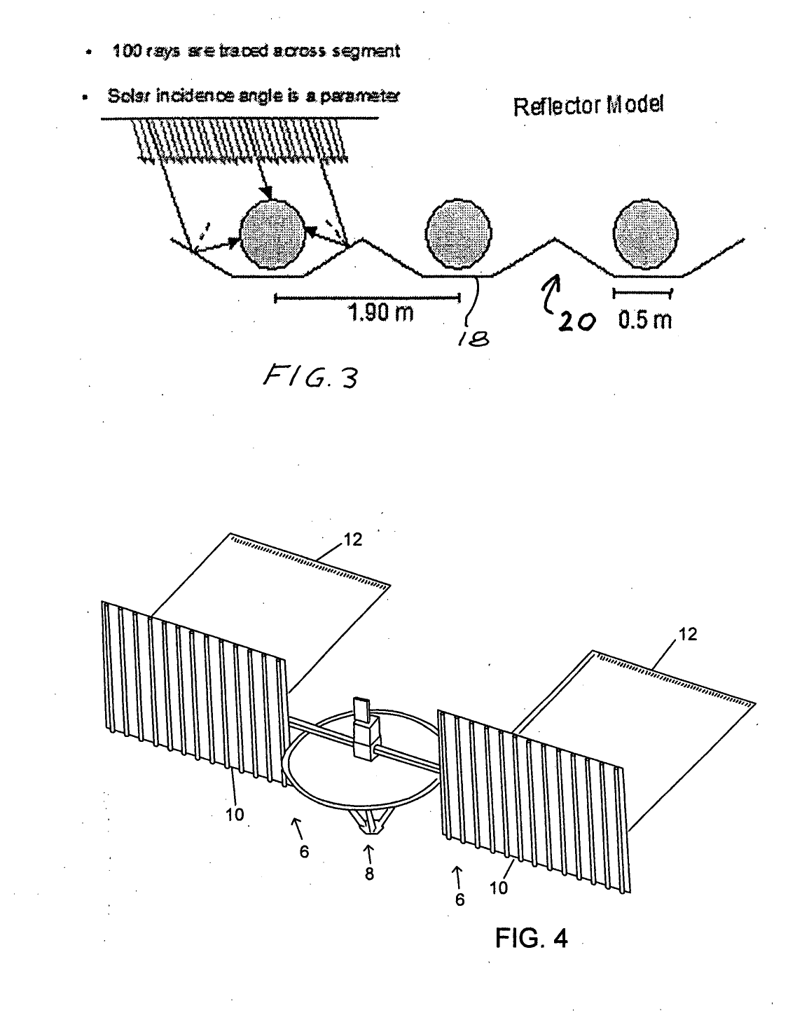

The GHB collector panels preferably are fitted with a reflector screen that is mounted “behind” the GHB panels as shown at 18 in FIG. 3. This screen is made of a lightweight flexible material coated with a reflective layer that is specular to solar wavelengths. The reflector screen is configured with supports and angular ridges as shown at 20 in FIG. 3 so that it reflects the solar energy that misses the GHB collectors (i.e. passes between the GHB collectors) back onto the sides and rear surfaces of the GHB collectors. The reflector also functions as an insulator that helps trap the small level of thermal energy emitted from the dark side of the GHB collector. The reflector also shields the radiator from direct sunlight.

The preferred reflector panels are comprised of a thin sheet of mylar that has a thin layer of aluminum deposited on it by vacuum deposition. Similar ultra-lightweight sheet material is manufactured and deployed for solar sails in spacecraft. A lightweight expandable mechanical structure for spacing and supporting the GHB bladders will also shape and support the reflector sheets. The reflector increases the effective collection area of the GHB, and the properties, design, and construction of the reflector determine the degree of increase. In the ideal reflector the GHB collection area is approximately equal to (GHB area+reflector area), but the anticipated system performance is somewhat below this ideal. The actual efficiencies will be determined through experiment.

### Radiator

The radiator system transfers the excess heat from the vapor after work is extracted from it in the turbine, and radiates it to space. There are several viable design options for this subsystem. The basic principal is that the waste heat must be spread over the radiator surface. To accomplish this, the waste heat is either transferred to a secondary heat transfer fluid through a heat exchanger, or the vapor itself can be cycled through the radiator surfaces. The heat transfer “spreading” can be accomplished with various designs such as heat pipes or pumped circulating fluids. The current embodiment of the system requires a radiator panel that has a large radiating surface area. The radiator is configured in the system so that it is turned at a right angle with respect to the GHB collector panel, which minimizes the solar heating of the radiator surfaces by the sun.

### Thermal Capacity

The thermal capacity of the GHB is important because during the eclipse periods where the satellite is shadowed from the sun by the earth, thermal energy can still be extracted from the hot GHB system which can be used to maintain the system during the eclipse period. The amount of available energy is a function of the mass of hot working fluid contained in the system, and this mass is limited by the mass budget at satellite launch.

The fluid reservoir mass is adjustable through the GHB diameter in the following manner. Given two GHB solar collection systems with equal collection area, the GHB system with larger diameter cylinders will contain a greater mass of working fluid than a GHB system with smaller diameter cylinders. The optimal GHB diameter is thus determined through a trade study. The GHB wall thickness and thus system mass is reduced by decreasing the GHB diameter, and a sufficient thermal reservoir to carry the system through the eclipse period is insured by increasing the GHB diameter. The outcome of the trade should provide a minimal mass for the GHB collector system, and a working fluid mass that fits within the launch vehicle's mass budget but provides the required thermal reservoir during eclipse.

### Working Fluid

The working fluid used in the system is currently pure water, which has several advantages. Water has a relatively low molecular weight which minimizes the mass that must be launched. Water boils in a temperature range in which materials are available that can contain it. Also, water condenses at a high enough temperature that a radiator with a surface area of reasonable size is feasible. Other potential working fluids such as ammonia or freon boil and condense at temperatures that are too low for exhausting excess heat efficiently by radiation. The use of mixtures of working fluid, such as water and ammonia may have potential for improving the system efficiency, such as in the Kalina thermodynamic cycle. Such mixtures of working fluid have not been fully explored, but are under consideration.

The amount of working fluid required to charge the system is determined by the total volume of the system, including the GHB and associated plumbing and heat exchanger. The optimum mass charge will generate the working pressure of saturated vapor in the system volume when raised to the working temperature. The working temperature and pressure are determined by the turbine cycle. In the present embodiment the working temperature is 160° C., which generates saturated steam at 100 psia.

### Power Collection Capacity

The total length of the GHB cylinders determines the power collection capacity of the system. In the current embodiment (without taking credit for the reflector panels) the diameter of the GHB cylinders is 0.5 meters and the total length of the cylinders is about 1200 meters, which provides a solar collection area of approximately 600 square meters. The addition of the reflector panel reduces the required total GHB length substantially from this value or provides some conservatism in the design.

### Radiator System

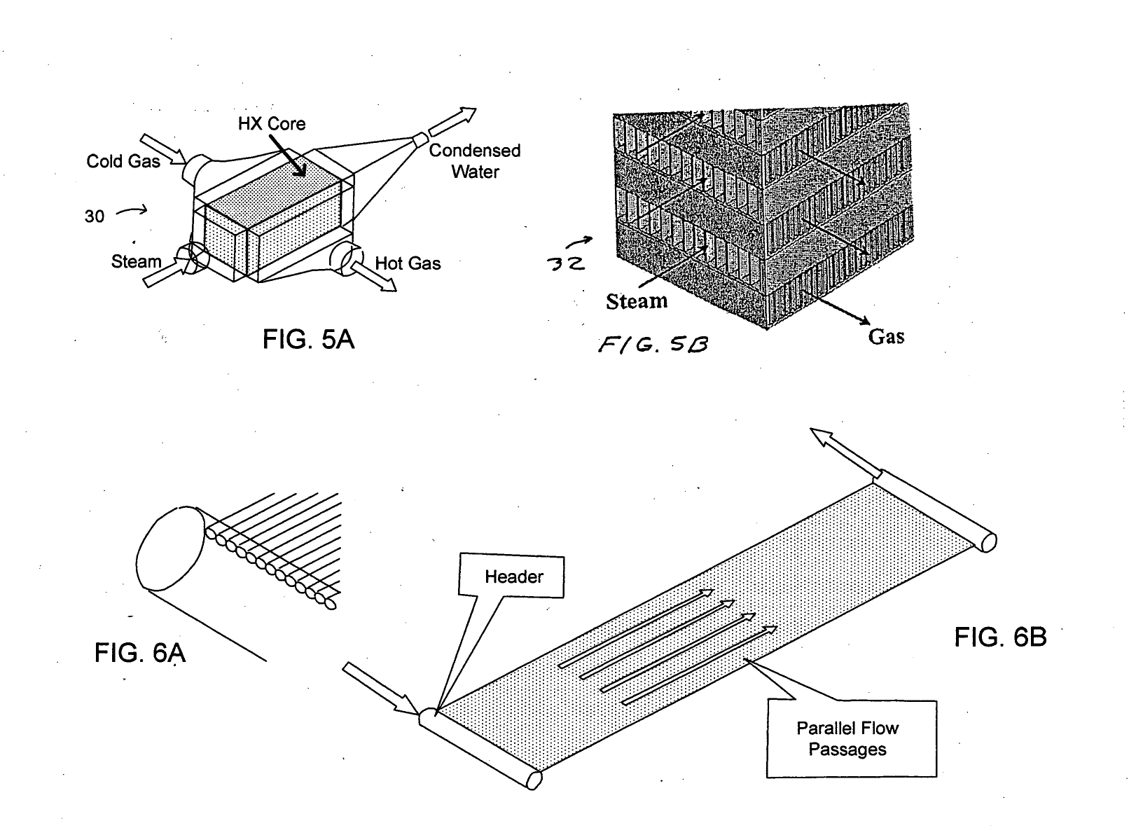

In a preferred embodiment of the present invention, the radiator system uses a secondary fluid to remove heat from the water/steam and distribute the heat to the radiator surface. This secondary fluid is currently a low molecular weight gas such as hydrogen, helium, nitrogen or methane. The gas absorbs the heat from the primary working fluid in a cross-flow heat exchanger as shown in FIG. 5. The heated gas is pumped though a “radiator panel” 30 consisting of an array of parallel tubes that is joined by an inlet and outlet manifold at 32 as shown in FIG. 6. The heat contained by the gas is transferred to the walls of the tubing as the gas transits their length, and from there is radiated to space.

Hydrogen is ideal since it has the highest heat capacity and thermal conductivity, and the lowest molecular weight of any gas. However, hydrogen is difficult to hold, since many materials are permeable to hydrogen, particularly when the materials are thin. The losses may be too high to be maintainable. Thus, other gasses are also being considered as the working fluid. The total area required of the radiator panels is a function of the thermodynamic properties of the working gas and the flow rate and pressure in the radiator panels. Applicants' current estimates are that a radiator area of 700 square meters will be required for each of the two systems. The material currently envisioned for the radiator panel array is Kapton, coated with a thin aluminum layer to minimize gas permeation.

### Variations

Preferred embodiments of the present invention have been described in detail above. However, a great many variations from these specific embodiments could be made and will be obvious to persons skilled in the art to which this invention belongs. For example, as indicated in the above text, the size of the power generating system could be expanded almost without limit. Tubes could be of sizes different from the 0.5 meter diameter considering various criteria including those specifically referred to above. Various materials can be applied including some that are not even available today.

Therefore, the scope of the invention should be determined by the appended claims and their legal equivalence and not by the specific embodiments described above.

What is claimed is:

1. A solar powered turbine driven electric generator system for generating electric power in extra-terrestrial locations, said system comprising:
A) a collector panel comprised of a plurality of collector tubes, each tube having walls comprised of thin flexible high-strength high temperature material with an outer surface having high absorptivity of solar radiation and low emissivity of thermal radiation,
B) a first working fluid defining a liquid phase and a vapor phase,
C) a turbine generator system adapted to electrical power from the vapor phase of the working fluid,
D) a radiator unit for radiating into space sufficient energy to convert the vapor phase of the working fluid exhausted from the turbine generator into a liquid phase.

2. The system as in claim 1 wherein the first working fluid is water.

3. The system as in claim 1 wherein the walls of the collector tubes are comprised of a composite material comprised of a polymer fiber.

4. The system as in claim 3 wherein the polymer fiber is Kevlar.

5. The system as in claim 3 wherein the walls are also comprised of a flexible rubbery material.

6. The system as in claim 5 wherein the flexible rubbery material is a Viton blend.

7. The system as in claim 1 wherein the walls of the tubes define outer surfaces that are coated with a coating that efficiently absorbs solar radiation and retains resulting heat energy.

8. The system as in claim 7 wherein the coating is comprised of three layers wherein the base layer is TiO₂, the middle layer is metallic silver and the top layer is TiO₂.

9. The system as in claim 1 wherein the walls of the tubes define inner surfaces that are coated with an inner surface material that blocks permeation of the working fluid through the walls and spreads heat laterally.

10. The system as in claim 9 wherein the inner surface material is a metal foil.

11. The system as in claim 1 wherein the turbine generator system comprises a plurality of turbine generator units.

12. The system as in claim 1 wherein the plurality of turbine generator units is two turbine generator units adapted to spin in opposite directions.

13. The system as in claim 1 wherein the collector tubes have diameters of about 0.5 meters.

14. The system as in claim 1 wherein the radiator unit comprises a heat exchanger for heating a second working fluid with warm vapor of the first working fluid to produce condensation of the first working fluid.

15. The system as in claim 14 wherein the second working fluid is hydrogen.

16. The system as in claim 1 wherein the entire system is adapted to fit in a cargo space of a space vehicle.

17. The system as in claim 16 wherein the space vehicle is an Atlas 5 HLV rocket.
